(19) United States
(12) Patent Application Publication
(10) Pub. No.: US 2011/0127461 A1
(43) Pub. Date: Jun. 2, 2011

(54) THERMALLY CONDUCTIVE COMPOSITION AND METHOD FOR PRODUCING THEM

(75) Inventors: Takahiro Fukuoka, Osaka (JP); Seiji Izutani, Osaka (JP)

(73) Assignee: Nitto Denko Corporation, Osaka (JP)

(21) Appl. No.: 12/737,644

(22) PCT Filed: Oct. 30, 2009
(86) PCT No.: PCT/JP2009/005779

§ 371 Date: Feb. 2, 2011

(30) Foreign Application Priority Data
Nov. 12, 2008 (JP) 2008-289600

(51) Int. Cl. C09K 5/00

(52) U.S. Cl. 252/74

(57) ABSTRACT

Disclosed is a thermally conductive composition obtained by a sol-gel method in which a sol containing inorganic particles, an alkoxysilane, and water is prepared, the sol is gelated to prepare a gel, and the gel is thermally cured.

### CROSS-REFERENCE TO RELATED APPLICATIONS

The present application is a 35 USC 371 national stage entry of PCT/JP2009/005779, filed Oct. 30, 2009, which claims priority from Japanese Patent Application No. 2008-289600 filed on Nov. 12, 2008, the contents of all of which are hereby incorporated by reference in their entirety.

### TECHNICAL FIELD

The present invention relates to a thermally conductive composition and a method for producing them, and more specifically to a thermally conductive composition that is preferably used in the technical area of power electronics and like technical areas and a method for producing them.

### BACKGROUND ART

Power electronics technology in which the conversion/control of electric power is performed with semiconductor elements is employed in hybrid devices, high-intensity LED devices, electromagnetic induction heating devices, and the like. In power electronics technology, large currents are converted into motion/light/heat, and therefore high heat dissipation (thermal conductivity) is required of sealing materials that seal and protect semiconductor elements.

For example, for securing high thermal conductivity a thermally conductive sheet has been proposed that is obtained by blending alumina with a sol in which a zirconium propoxide solution and a dimethylsiloxane solution are mixed, molding the sol into a sheet, and thermally gelating the sheet (e.g., see Patent Document 1 below).
Patent Document 1: Japanese Unexamined Patent Publication No. 2005-81669 (Example 1)

### DISCLOSURE OF THE INVENTION

### Problems to be Solved

In the thermally conductive sheet described in the aforementioned Patent Document 1, while alumina is dispersed in a matrix of dimethylsiloxane, this alumina and dimethylsiloxane are physically in contact with each other without being chemically bonded. Therefore, a large thermal resistance is produced at the interface between the alumina and the dimethylsiloxane, and an enhancement of thermal conductivity is limited.

An object of the present invention is to provide a thermally conductive composition having excellent thermal conductivity and a method for producing them.

### Means for Solving the Problem

It is a feature of the thermally conductive composition of the present invention that, to achieve the above-described object, the thermally conductive composition is obtained by a sol-gel method from inorganic particles and an alkoxysilane.

In the thermally conductive composition of the present invention, it is preferable that the inorganic particles are composed of at least one inorganic material selected from the group consisting of carbides, nitrides, oxides, metals, and carbon-based materials.

In the thermally conductive composition of the present invention, it is preferable that a carbide and a nitride are concomitantly used for the inorganic material.

In the thermally conductive composition of the present invention, it is preferable that the alkoxysilane is a trialkoxysilane and/or a tetraalkoxysilane.

It is preferable that the thermally conductive composition of the present invention is obtained by preparing a sol containing inorganic particles, an alkoxysilane and water, gelating the sol to prepare a gel, and thermally curing the gel.

It is a feature of the thermally conductive composition of the present invention that inorganic particles are dispersed in a matrix composed of polysiloxane, and the inorganic particles and the polysiloxane are chemically bonded to each other.

It is a feature of the method for producing a thermally conductive composition of the present invention that the method includes the steps of preparing a sol containing inorganic particles, an alkoxysilane and water, gelating the sol to preparing a gel, and thermally curing the gel.

### Effect of the Invention

In the thermally conductive composition and the method for producing them of the present invention, inorganic particles are dispersed in a matrix composed of polysiloxane, and the inorganic particles and the polysiloxane are chemically bonded to each other. Therefore, the heat of the inorganic particles can be dissipated among the inorganic particles via the polysiloxane, and it is thus possible to obtain excellent thermal conductivity.

As a result, the thermally conductive composition can be preferably used in power electronics technology as a sealing material for sealing and protecting semiconductor elements.

### EMBODIMENT OF THE INVENTION

The thermally conductive composition of the present invention can be obtained by a sol-gel method from inorganic particles and an alkoxysilane.

In the present invention, the inorganic particles are composed of, for example, an inorganic material, and examples of such inorganic materials that form the inorganic particles include carbides, nitrides, oxides, metals, and carbon-based materials.

Examples of carbides include silicon carbide, boron carbide, aluminium carbide, titanium carbide, and tungsten carbide.

Examples of nitrides include silicon nitride, boron nitride, aluminium nitride, gallium nitride, chromium nitride, tungsten nitride, magnesium nitride, molybdenum nitride, and lithium nitride.

Examples of oxides include silicon oxide (silica), aluminium oxide (alumina), magnesium oxide (magnesia), titanium oxide, and cerium oxide. Furthermore, examples of oxides include indium tin oxide and antimony tin oxide that are doped with metal ions.

Examples of metals include copper, gold, nickel, tin, iron, and alloys of such metals.

Examples of carbon-based materials include carbon black, graphite, diamond, fullerene, carbon nanotubes, carbon nanofibers, nanohoms, carbon microcoils, and nanocoils.

Inorganic materials may be used singly or as a combination of two or more.

Among such inorganic materials, carbides, nitrides, and oxides are preferable.

The inorganic material is preferably a carbide and a nitride that are used concomitantly. Specifically, the inorganic material may be silicon carbide and boron nitride that are used concomitantly.

A carbide such as silicon carbide has high thermal conductivity, and it is thus preferable as the inorganic material in the present invention (the thermal conductivity of silicon carbide is 200 W/m·K). At the same time, silicon carbide is a very hard inorganic material and barely deforms when pressure is applied. Therefore, in the case where a carbide such as silicon carbide is used singly as the inorganic material, voids are created between inorganic particles when a thermally conductive composition is formed by applying pressure, and thus it may not be possible to attain excellent thermal conductivity.

On the other hand, a nitride such as boron nitride is an inorganic material that readily deforms when pressure is applied. Therefore, the concomitant use of a carbide and a nitride such as boron nitride as the inorganic material can reduce voids between inorganic particles when a thermally conductive composition is formed by applying pressure. Therefore, the concomitant use of silicon carbide and boron nitride can create much greater thermal conductivity than the use of a carbide alone.

The inorganic particles can be obtained in the form of particles composed of the aforementioned inorganic material without any treatment, or alternatively they can be obtained by shaping the aforementioned inorganic material into particles according to a known method such as grinding. The shape of the particles is not particularly limited, and examples include a spherical shape (alumina, silicon carbide, and the like) and a plate-like shape (boron nitride and the like).

The maximum length of the particles is, for example, 3 to 50000 nm. In particular, for spherical particles the average particle diameter is, for example, 100 to 50000 nm and preferably 500 to 20000 nm, and for plate-like particles the maximum length is, for example, 200 to 50000 nm and preferably 500 to 45000 nm.

Preferably, spherical particles and plate-like particles are used concomitantly for the inorganic particles. Such concomitant use allows the inorganic particles to be more uniformly loaded in the matrix in the thermally conductive composition, enabling the particles to be more uniformly dispersed. In the case where spherical particles and plate-like particles are used concomitantly, the average particle diameter of the spherical particles is, for example, 5 to 300% and preferably 10 to 200% of the maximum length of the plate-like particles being 100%.

For example, particles having different maximum lengths can also be used concomitantly for the inorganic particles, and for example, inorganic particles having a maximum length of 2 to 5 μm (small particles) and inorganic particles having a maximum length of 20 to 50 μm can also be used concomitantly. When small particles and large particles are used concomitantly, the maximum length of the large particles is preferably from no less than 8 to usually no more than 30 times greater than the maximum length of the small particles.

Alkoxysilanes are, for example, silane compounds that have a plurality of alkoxy groups within the molecule, and specific examples include dialkoxysilanes, trialkoxysilanes, and tetraalkoxysilane.

Examples of dialkoxysilanes include (glycidoxyalkyl)alkyldiethoxysilanes such as (3-glycidoxypropyl)methyldiethoxysilane, and aminoalkyl-alkyldimethoxysilanes such as N-(2-aminoethyl)-3-aminopropylmethyl-dimethoxysilane.

Examples of trialkoxysilanes include vinyl-trialkoxysilanes such as vinyl-tris(β-methoxyethoxy)silane, vinyl-triethoxysilane, and vinyl-trimethoxysilane; (methacryloyloxyalkyl)trialkoxysilanes such as 3-(methacryloyloxypropyl)trimethoxysilane; (epoxycycloalkyl)alkyltrialkoxysilanes such as 2-(3,4-epoxycyclohexyl)ethyltrimethoxysilane; glycidoxyalkyltrialkoxysilanes such as 3-glycidoxypropyltrimethoxysilane; aminoalkyltrialkoxysilanes such as N-(2-aminoethyl)-3-aminopropyltrimethoxysilane, 3-aminopropyltriethoxysilane, and N-phenyl-3-aminopropyltrimethoxysilane; mercaptoalkyltrialkoxysilanes such as 3-mercaptopropyltrimethoxysilane; and halogenoalkyltrialkoxysilanes such as 3-chloropropyltrimethoxysilane.

Examples of tetraalkoxysilanes include tetramethoxysilane, tetraethoxysilane, tetrapropoxysilane, tetraisopropoxysilane, tetrabutoxysilane, tetraisobutoxysilane, tetra-sec-butoxysilane, and tetra-tert-butoxysilane.

Such alkoxysilanes can be used singly or as a combination of two or more.

Among such alkoxysilanes, trialkoxysilanes and tetraalkoxysilanes are preferable, with trialkoxysilanes being particularly preferable. A specific example is a glycidoxyalkyl-trialkoxysilane.

The use of a trialkoxysilane and a tetraalkoxysilane allows polysiloxane to be formed by their polymerization into a three-dimensional network structure, thereby enabling a strong polysiloxane matrix to be produced.

Trialkoxysilanes are easier to handle than tetraalkoxysilanes.

The thermally conductive composition of the present invention is then obtained by a sol-gel method from the above-described inorganic particles and alkoxysilane.

Specifically, in the sol-gel method, a sol containing inorganic particles, an alkoxysilane, and water is prepared first.

To prepare the sol, for example, first, water and optionally a catalyst (for example, an organic acid such as acetic acid or an inorganic acid such as sulfuric acid, hydrochloric acid, or nitric acid) are blended with the above-described alkoxysilane to hydrolyze the alkoxysilane to prepare an aqueous solution, and the inorganic particles are blended with this aqueous solution.

An alcohol can be added as necessary to the aqueous solution to prepare a uniform aqueous solution. Examples of alcohols include lower alcohols having 1 to 4 carbon atoms, such as methanol, ethanol, propanol, and butanol. The pH of the sol is controlled so as to be 2 to 6 and preferably 3 to 5.

The proportions of the respective components of the sol are such that water is in, for example, 10 to 100 parts by weight and preferably 10 to 80 parts by weight, catalyst is in, for example, 1 to 20 parts by weight, and alcohol is in, for example, 50 parts by weight or less and preferably 20 parts by weight or less, per 100 parts by weight of alkoxysilane.

The proportion of the inorganic particles is, for example, 10 to 5000 parts by weight and preferably 100 to 2000 parts by weight per 100 parts by weight of the alkoxysilane. In the case where spherical particles and plate-like particles are used concomitantly for the inorganic particles, for example, the plate-like particles are in 5 to 2000 parts by weight and preferably 30 to 300 parts by weight per 100 parts by weight of the spherical particles.

Next in this method, the resulting sol is gelated to prepare a gel. Specifically, the sol is first introduced into a container of any shape and then left to stand at, for example, 20 to 90° C., preferably 20 to 50° C., and more preferably 20 to 40° C. for, for example, 1 to 50 hours and preferably 5 to 30 hours to subject the alkoxysilane to a dehydrative condensation reaction for the gelation of the sol.

Next in this method, the gel is thermally cured.

Specifically, the gel is first heated to, for example, 50 to 90° C. and preferably 60 to 80° C. volatilize and to remove the alcohol generated by the dehydrative condensation reaction. After the alcohol removal, the gel is heated to 100 to 180° C. and preferably 130 to 160° C. to dry the remaining water, and an article composed of a thermally conductive composition (for example, a thermally conductive sheet or the like) is obtained in a desired shape.

An article composed of a thermally conductive composition can also be obtained by hot-pressing the sol in the above-described preparation and curing of the gel.

Specifically, the sol is first introduced into a container of any shape and then hot-pressed under press conditions of a press temperature of, for example, 100 to 180° C. and preferably 130 to 160° C., a pressure of, for example, 100 to 500 MPa and preferably 200 to 400 MPa, and a press time of, for example, 5 to 30 minutes and preferably 10 to 15 minutes.

This hot-pressing enables an article composed of a high-density thermally conductive composition to be obtained.

In the thermally conductive composition of the present invention obtained in this manner, inorganic particles are dispersed in a matrix composed of polysiloxane, and the inorganic particles and the polysiloxane are chemically bonded to each other.

That is, in the thermally conductive composition, polysiloxane is formed into a three-dimensional network structure due to the polymerization of alkoxysilane, and inorganic particles are dispersed in a matrix composed of the polysiloxane. Accordingly, the hydroxyl group (when the inorganic particles are composed of an oxide), the amino group (when the inorganic particles are composed of a nitride), the carboxyl group (when the inorganic particles are composed of a carbide), or a like group present on the surface of the inorganic particles and the terminal siloxane group of the polysiloxane are hydrogen-bonded to each other.

That is, the inorganic particles and the polysiloxane are chemically bonded very densely due to the siloxane linkage of the polysiloxane as well as the hydrogen bonding between the inorganic particles and the polysiloxane. Therefore, the heat of the inorganic particles can be uniformly dissipated among the inorganic particles via the polysiloxane, and the thermal resistance produced among the inorganic particles is thus considerably reduced. As a result, excellent thermal conductivity can be obtained.

As a result, the thermally conductive composition can be preferably used in power electronics technology as a sealing material for sealing and protecting semiconductor elements.

### EXAMPLES

Although Examples and Comparative Examples are presented below to describe the present invention in more detail, the present invention is not limited to the Examples and Comparative Examples.

### Example 1

1.0 g of ethanol, 3.0 g of water, and 0.1 g of acetic acid were blended with 5.0 g of 3-glycidoxypropyltrimethoxysilane (KBM403, manufactured by Shin-Etsu Chemical Co., Ltd.) and mixed by stirring these ingredients to hydrolyze the 3-glycidoxypropyltrimethoxysilane, thereby giving an aqueous solution. Then, 0.9 g of the aqueous solution was blended and mixed with 5.0 g of alumina (AS-50, spherical particles, average particle diameter of 9 μm, manufactured by Showa Denko K.K.) that had been dried in advance at 40° C. for 1 day, and a sol was thus prepared.

Then, the resulting sol was poured into a cylindrical polytetrafluoroethylene (PTFE) container having a diameter of 25 mm and a depth of 20 mm. Subsequently, the container was left to stand at 25° C. at 50% RH for 12 hours to allow the sol to sufficiently react (dehydrative condensation reaction), thereby giving a gel. Thereafter, the gel was heated at 80° C. for 2 hours to volatize and remove an alcohol and further heated at 130° C. for 2 hours to remove water, thereby giving a thermally conductive sheet having a thickness of 0.2 mm that appeared circular when viewed planarly.

### Example 2

A sol was prepared in the same manner as in Example 1 except that 1.77 g of boron nitride (HP-40, plate-like particles, maximum length of 40 μm, manufactured by Mizushima Ferroalloy Co., Ltd.) and 1.65 g of silicon carbide (HSC500, spherical particles, average particle diameter of 17 μm, manufactured by Superior Graphite) were used concomitantly in the sol preparation in place of 5.0 g of the alumina used in Example 1, and subsequently a gel was prepared and heated, thereby giving a thermally conductive sheet having a thickness of 0.5 mm.

### Example 3

A sol was prepared in the same manner as in Example 1 except that 1.62 g of boron nitride (HP-40, plate-like particles, maximum length of 40 manufactured by Mizushima Ferroalloy Co., Ltd.) and 3.38 g of silicon carbide (HSC500, spherical particles, average particle diameter of 17 μm, manufactured by Superior Graphite) were used concomitantly in the sol preparation in place of 5.0 g of the alumina used in Example 1, and subsequently a gel was prepared and heated, thereby giving a thermally conductive sheet having a thickness of 0.5 mm.

### Example 4

A sol was prepared in the same manner as in Example 1 except that 4.4 g of tetraethoxysilane (KEB04, manufactured by Shin-Etsu Chemical Co., Ltd.) was used in the sol preparation in place of 5.0 g of the 3-glycidoxypropyltrimethoxysilane (KBM403, manufactured by Shin-Etsu Chemical Co., Ltd.) used in Example 1, and subsequently a gel was prepared and heated, thereby giving a thermally conductive sheet having a thickness of 0.4 mm.

### Comparative Example 1

A thermally conductive sheet was obtained according to Example 1 of Japanese Unexamined Patent Publication No. 2005-81669.

That is, 1 mol of zirconium propoxide and 0.5 mol of ethyl acetoacetate were reacted under a nitrogen atmosphere to prepare zirconium propoxide chemically modified by ethyl acetoacetate, and 0.35 mol of heat-treated dimethylsiloxane (XF3905, weight average molecular weight of 20000, manufactured by GE Toshiba Silicones) was added thereto to prepare a sol.

Then, 750 g of alumina was blended with 100 g of the sol, and kneading and then vacuum extrusion molding were carried out, thereby giving a thermally conductive sheet. The alumina used was prepared by blending aluminium oxide (AL-30, spherical particles, average particle diameter of 3000 nm, manufactured by Showa Denko K.K.) with aluminium oxide (AS-10, spherical particles, average particle diameter of 40000 nm, manufactured by Showa Denko K.K.) in a mass ratio of 1:4.

Then, the sheet was cured by successively heating it at 100° C. for 2 hours, at 120° C. for 2 hours, at 150° C. for 2 hours, at 180° C. for 2 hours, at 200° C. for 2 hours, at 250° C. for 2 hours, and at 300° C. for 2 hours, thereby giving a thermally conductive sheet having a thickness of 0.3 mm.

### Comparative Example 2

103 g of methyl ethyl ketone was added to 33 g of a curing agent (acid anhydride, MH700, manufactured by New Japan Chemical Co., Ltd), 3 g of a curing accelerator (2-phenylimidazole, manufactured by Shikoku Chemicals Corporation), 45 g of a bisphenol A epoxy resin (Epicoat 1010, manufactured by Japan Epoxy Resins Co. Ltd.), and 55 g of a biphenyl epoxy resin (NC3000H, manufactured by Nippon Kayaku Co., Ltd.) to dissolve the respective ingredients to prepare an epoxy resin solution (solids content: 57 wt %).

286 g of the epoxy resin solution and alumina (AS-50, manufactured by Showa Denko K.K.) were introduced into a T.K. Hivis Mix (manufactured by Primix Corporation) and stirred for 20 minutes under reduced pressure, thereby giving an alumina-containing epoxy resin solution. Then, after returning to ordinary pressures, the alumina-containing epoxy resin solution was applied to a copper foil and dried to form a sheet.

Thereafter, the sheet was cured by heating it at 150° C. for 20 minutes and further at 160° C. for 20 minutes under a pressure of 6.0 MPa using a hot press, thereby giving a thermally conductive sheet having a thickness of 0.1 mm.

The volume ratio of alumina in the resulting thermally conductive sheet was about 50 volume %.

### (Evaluation)

### Thermal Conductivity (Evaluation of Heat Dissipation)

The thermal conductivity of the thermally conductive sheets obtained in Examples 1 to 4 and Comparative Examples 1 and 2 was determined according to the laser flash method. Table 1 shows the results.

TABLE 1

| Examples and | Thermal conductivity |
|---|---|
| Comparative Examples | (W/m · K) |
| Example 1 | 13 |
| Example 2 | 22 |
| Example 3 | 24 |
| Example 4 | 10 |
| Comparative Example 1 | 6.0 |
| Comparative Example 2 | 1.2 |

While the illustrative embodiments of the present invention are provided in the above description, they are for illustrative purposes only and not to be construed limiting. Modification and variation of the present invention that will be obvious to those skilled in the art is to be covered by the following claims.

### INDUSTRIAL APPLICABILITY

The thermally conductive composition of the present invention can be preferably used in power electronics technology as a sealing material for sealing and protecting semiconductor elements.

1. A thermally conductive composition obtained by a sol-gel method from inorganic particles and an alkoxysilane.

2. The thermally conductive composition according to claim 1, wherein the inorganic particles are composed of at least one inorganic material selected from the group consisting of carbides, nitrides, oxides, metals, and carbon-based materials.

3. The thermally conductive composition according to claim 2, wherein a carbide and a nitride are concomitantly used for the inorganic material.

4. The thermally conductive composition according to claim 1, wherein the alkoxysilane is a trialkoxysilane and/or a tetraalkoxysilane.

5. The thermally conductive composition according to claim 1, which is obtained by preparing a sol comprising the inorganic particles, the alkoxysilane and water, gelating the sol to prepare a gel, and thermally curing the gel.

6. A thermally conductive composition in which inorganic particles are dispersed in a matrix composed of polysiloxane,
the inorganic particles and the polysiloxane being chemically bonded to each other.

7. A method for producing a thermally conductive composition, comprising the steps of
preparing a sol containing inorganic particles, an alkoxysilane and water,
gelating the sol to prepare a gel, and
thermally curing the gel.
